(19) United States
(12) Patent Application Publication
(10) Pub. No.: US 2023/0092576 A1
(43) Pub. Date: Mar. 23, 2023

(54) PREDOMINANTLY AMORPHOUS SILICON PARTICLES AND USE THEREOF AS ACTIVE ANODE MATERIAL IN SECONDARY LITHIUM ION BATTERIES

(71) Applicant: CENATE AS, Askim (NO)

(72) Inventors: Martin Kirkengen, Askim (NO); Erik Sauar, Oslo (NO); Werner Filtvedt, Askim (NO)

(73) Assignee: CENATE AS, Askim (NO)

(21) Appl. No.: 17/760,281

(22) PCT Filed: Feb. 12, 2021
(86) PCT No.: PCT/EP2021/053493

§ 371 Date: Aug. 5, 2022

(30) Foreign Application Priority Data
Feb. 14, 2020 (GB) 2002064.0
Oct. 29, 2020 (GB) 2017168.2

(51) Int. Cl. C01B 32/977; H01M 10/0525

(52) U.S. Cl. CPC C01B 32/977; H01M 10/0525; C01P 2006/40; C01P 2004/64; C01P 2002/72

(57) ABSTRACT

A method for manufacturing predominantly amorphous silicon-containing particles includes a chemical compound of formula: Si₍₁₋ₓ₎Cₓ, where 0.005≤x<0.05. The particles, when subjected to XRD analysis applying unmonochromated CuKα radiation, exhibit one peak at around 28° and one peak at around 52°. Both peaks have a Full Width at Half Maximum of at least 5° when using Gaussian peak fitting. The method includes forming a homogeneous gas mixture of a first precursor gas of a silicon containing compound and at least one second precursor gas of a substitution element M containing compound, injecting the homogeneous gas mixture of the first and second precursor gases into a reactor space where the precursor gases are heated to a temperature in the range of from 700 to 900° C. so that the precursor gases react and form particles, and collecting and cooling the particles to a temperature in the range of from ambient temperature up to about 350° C. The relative amounts of the first and the second precursor gases are adapted such that the formed particles obtain an atomic ratio C: Si in the range of [0.005, 0.05).

The present invention concerns a method for manufacturing predominantly amorphous silicon particles, the particles made thereof, and a secondary electrochemical cell utilising the particles as the active material of the negative electrode of the secondary electrochemical cell.

### BACKGROUND

It will be necessary with a strong increase in the usage of renewable power and the electrification of many sectors in the society presently running on fossil fuel energy to meet the goals of The Paris Agreement under the UN Climate Convention. A vital part to obtain these goals is access to rechargeable batteries having excellent specific energies.

Lithium has a comparably very low density of 0.534 g/cm³ and also a high standard reduction potential of −3.045 V for the half-reaction Li⁺+e⁻→Li⁰. This makes lithium an attractive candidate for making electrochemical cells with specific energy. However, secondary (rechargeable) electrochemical cells having a negative electrode of metallic lithium have shown to be encumbered with a persistent problem of dendrite formation upon charging which tends to short-circuit the electrochemical cell after a few charge-discharge cycles.

The dendrite problem was solved by applying a negative electrode capable of releasably storing lithium atoms by intercalation. Such batteries are known as secondary lithium-ion batteries (LIBs). The electrochemical properties of LIBs are directly influenced by the physical and chemical properties of the active material(s) of the negative electrode. Both material choice and preparation as well as appropriate architectural modification and design of the active material affects the battery performance [1]. A key problem in this regard was, and still is, to find active materials which may reliably and reversibly store lithium atoms at a high volumetric density when the battery is charged and then release the lithium as ions (Li⁺) when being discharged in a high number of successive charge-discharging cycles.

At present, most of the commercially available LIBs apply graphite as the active material of the negative electrode. Graphite may host/pack one lithium-ion per six carbon atoms by intercalation with little shape deformation and has a theoretical specific energy of 372 mAh/g. Commercially available secondary LIBs with graphite anodes typically obtain a specific energy of 100-200 Wh/kg, making e.g. a mid-size electric car battery weigh several hundred kilos. This level of specific energy is probably insufficient to realise the goal of the Paris Agreement.

### PRIOR ART

One strategy for improving the specific energy of LIBs is to find materials having higher storage capacity of lithium-ions than graphite for use as the active material of the negative electrode. One interesting and much investigated candidate in this regard is silicon, due to its high capacity for storing lithium atoms by diffusion and alloying. At typical ambient temperatures, the most lithiated phase of silicon is Li_{3.75}Si having a theoretic specific capacity of 3579 mAh/g [1]. Negative electrodes of silicon also have the benefit of enabling providing an attractive working potential reducing the safety concerns related to lithium deposition upon cell over-charge [2].

The lithiation and delithiation of silicon causes huge volume expansions and contractions, respectively in the silicon material. At is most lithiated state of Li_{3.75}Si, the silicon material has a volume of around 320% higher than the non-lithiated state. The relatively large volume variation associated with lithiation and delithiation cycles is reported to cause cracking and/or dissipation of the silicon electrode and/or repeated formation of a solid electrolyte interface (SEI) layer, which may lead to a range of problems for the performance of the LIB such as loss of electric contact, loss of active material in the electrode, ineffective electron transfer, etc. [1, 2].

Nanostructuring of the silicon material has been investigated as a solution to overcome the volume expansion issue since nanoscale Si-particles may better accommodate the volume variations [2]. It has been demonstrated that use of nanoscale particles in electrodes may provide electrodes with outstanding properties due to the small particle size causing effects such as improved electrical conduc-tivity, improved mechanical and optical properties, etc. [1]. Furthermore, since nanosized particles have a very high surface area to volume ratio, negative electrodes having nanosized active materials may provide excellent charge/-discharge capacity due to high available surface for absorption/desorption of lithium-ions [1].

The interatomic distance between silicon atoms increases as it accommodates lithium ions (lithiation), so that the particles may swell to a maximum of 320% more than their original volume. For crystalline silicon, the expansion causes large anisotropic stresses to occur within the electrode material, leading to increased fracturing and crumbling of the silicon material. This anisotropic stress has been found to be reduced in many anode configurations if the silicon material itself is amorphous [5].

For LIBs having a liquid electrolyte, there will often be formed a solid electrolyte interface (SEI) during the first lithiation. The formation of the SEI-layer irrevers-ibly consumes lithium and represents an irreversible capacity loss to the electrochemical cell [1]. It is therefore advantageous to form a stable SEI-layer to limit the SEI-induced loss of lithium to the first lithiation/charging of the cell. It has been demonstrated that coating the silicon surface with a suitable element to avoid direct contact between the silicon and the electrolyte may provide a stable SEI-layer [1], but if cracks occur, unprotected surfaces will appear.

Carbon has been investigated and applied both as a coating material and/or as a composite material together with silicon in LIBs having nanostructured silicon as the active material in the negative electrode. Numerous silicon-carbon structures are reported in the literature, ranging from simple mixtures of silicon to complex geometries of silicon with graphene or graphite. These complex structures may exhibit excellent cyclability and capacity but are encumbered with requiring many charge-discharge cycles to reach high coulombic efficiencies and they require multi-step synthesis processes which are complicated to scale-up to commercial production levels [2].

From Sourice et al. (2016) [2] it is known a method for producing nanoscale amorphous silicon particles having a carbon shell/coating by a two-stage laser pyrolysis process where a gaseous flow of silane diluted in an inert gas enters a first reaction zone irradiated by a CO₂-laser to decompose the silane gas into amorphous silicon core particles. To the gas with the formed silicon core particles there is then added ethylene and the mixture is passed to a second reaction zone and irradiated by a CO₂-laser to decompose the ethylene into a carbon shell deposited onto the silicon core particles. The amorphous silicon particles with a carbon coating are found to have excellent specific capacity and high charge/discharge-cycling capability.

US 2012/0107693 discloses an active material for the negative electrode of a LIB including a silicon-containing compound of formula: SiCₓ, where x may be from 0.05 to 1.5, and where the carbon concentration in the material follows the relationship A≤B, where A is the mole concentration ratio of carbon relative to silicon at the centre of the active material and B is the mole concentration ratio of carbon relative to silicon on/at the surface area of the active material. The document informs that the carbon may be covalently bonded to the silicon and further that the silicon-containing compound may be particulate and have an amorphous molecular structure. It is further disclosed in paragraph [0030] of US 2012/0107693 that if the carbon content in the active material becomes too low, i.e. if x becomes less than 0.05, the active material may be deteriorated by cracking.

From EP 2 405 509 it is known an active material of a negative electrode for rechargeable LIBs including an amorphous silicon-based compound of formula: SiA_{X}H_{y}, where A is either carbon, nitrogen or a combination thereof, and where x>0, y>0, and 0.1≤x+y≤1.5. The active material may be particulate and coated by a carbon layer. The active material may be prepared by a sputtering process applying hydrogen gas and Si and C targets, or by a plasma method using hydrogen gas, silane gas and nitrogen gas.

WO 2018/052318 discloses a reactor and method for manufacturing crystalline or amorphous silicon particles by chemical vapour deposition of a silicon-containing precursor onto seed particles inside a heated and rapidly rotating reactor space. The silicon-containing gas may be diluted in a carrier gas and it may be one or a mixture of SiH₄, Si₂H₆, or SiHCl₃. The carrier gas may be one of hydrogen, nitrogen or argon. The formed silicon particles may be given an outer layer of a second material having lower silicon content than the core material of the particles by introducing a second precursor gas, liquid or material comprising C, O or N in combination with silicon, such as SiOₓ, SiCₓ, SiNₓ; amorphous carbon, graphite, low-crystalline carbon or low range order graphene structures.

Wang et al (2013) [6] is one of several research groups that have disclosed the formation of a secondary particle from silicon nanoparticles and a carbon precursor such as pitch, and the use of such particles in a Li-ion battery. The secondary particle reduces the interface area between silicon and electrolyte, and thereby reduces formation of Solid Electrolyte Interphases (SEI), which are known to consume both lithium and electrolyte, thereby gradually reducing the capacity of the battery. The formation of (SEI) in the first cycles is quantified by measuring the Coulombic Efficiency (CE) of the first lithiation cycles, and the SEI thickness and quality can furthermore be estimated using XPS. It has been demonstrated by Jeff Dahn (1995) [7] that the CE of carbon formed from pitch or sugars is improved if the carbonization can occur at >500° C., preferably >700° C., more preferably >800° C. for at least two hours. Escamilla-Perez et al. (2019) [8] even pyrolyzed for 3 hours at 900° C.

EP 3 025 702 A1 discloses extremely pure, nanoparticulate, amorphous silicon powders, which can preferably be alloyed with electron donors and/or electron acceptors. Furthermore, a method for producing the silicon powder and the use of a reactor for producing the silicon powder are disclosed. The silicon powders according to the invention can preferably be used for the production of semiconductor starting materials, semiconductors, thermocouples for energy recovery from waste heat, in particular thermocouples which are stable at high temperatures.

KR 2016/0009807 discloses a silicon nanoparticle and a preparing method of the same. Particularly, this document relates to a silicon nanoparticle which comprises silicon as an active ingredient and has a non-crystalline or amorphous phase by having an excessive amount of atom P or atom B inside/outside the nanoparticle over a doping limit, and to a preparing method of the nanoparticle. The silicon nanoparticle produced can improve charging/discharging cycles (lifespan) of a secondary battery which uses the silicon nanoparticle as an anode material by having a second order phase of a non-crystalline or amorphous phase which acts as a shock absorber regarding volumetric expansion and contraction occurring during charging/discharging of silicon.

### OBJECTIVE OF THE INVENTION

The main objective of the invention is to provide a method for manufacturing predominantly amorphous silicon-containing particles suitable for use as the active material in negative electrodes in rechargeable lithium-ion electrochemical cells.

A further objective of the invention is to provide predominantly amorphous silicon-containing particles made by the method.

A further objective of the invention is the provision of an anode material comprising the predominantly amorphous silicon-containing particles.

A further objective of the invention is the provision of a secondary electrochemical cell having a negative electrode comprising the predominantly amorphous silicon-containing particles.

### DESCRIPTION OF THE INVENTION

The present invention is based on the discovery that applying a mixture of a silicon precursor gas and a relatively minor amount of a substitution element precursor gas heated to a temperature where the gases decompose and react to form solid particles produces silicon particles having a predominantly amorphous structure being heat-tolerant—in the sense of not transforming to the crystalline state at temperatures which a similar sample of particles without said guest element and heated for the same duration of time cannot withstand without a measurable fraction transforming to the crystalline phase. The ability of the silicon particles to maintain in the amorphous state at relatively high temperatures is beneficial from a process economical perspective by enabling higher yield rates and increased tolerance to thermal treatment during subsequent production steps. It is further beneficial a battery performance perspective when applying the particles as active material in the negative electrode of secondary lithium ion batteries since nanoscale amorphous Si-particles have increased tolerance for the volumetric changes associated with lithiation and delithiation and provide the negative electrode with improved cyclability.

Thus, in a first aspect, the invention relates to a method for manufacturing predominantly amorphous silicon-containing particles comprising a chemical compound of formula: Si₍₁₋ₓ₎Mₓ, where 0.005≤x<0.05 and M is at least one substitution element chosen from; C, N, or a combination thereof, and where the particles, when subjected to XRD analysis applying unmonochromated CuKα radiation, exhibit one peak at around 280 and one peak at around 52°, and where both peaks have a Full Width at Half Maximum of at least 5° when using Gaussian peak fitting,

wherein the method comprises:
forming a homogeneous gas mixture of a first precursor gas of a silicon containing compound and at least one second precursor gas of a substitution element M containing compound,
injecting the homogeneous gas mixture of the first and second precursor gases into a reactor space where the precursor gases are heated to a temperature in the range of from 700 to 900° C. so that the precursor gases react and form particles, and
collecting and cooling the particles to a temperature in the range of from ambient temperature up to about 350° C., and wherein
the relative amounts of the first and the second precursor gases are adapted such that the formed particles obtain an atomic ratio M: Si in the range of [0.005, 0.05).

The homogeneous gas mixture may in example embodiments further comprise additional inert gases such as e.g. hydrogen, nitrogen, argon, neon, helium, and other gases which may be applied to affect heating, cooling, particle formation kinetics or mass transport, but will not leave chemical impurities in the final particle product. The heating of the precursor gases in the reaction chamber may be achieved by convection, conduction, radiation, laser, mixing with warmer gases or any other known method.

The particles made by the first aspect of the invention are predominantly amorphous silicon-containing particles, wherein:

the particles comprises a chemical compound of formula: Si₍₁₋ₓ₎Mₓ, where 0.005≤x<0.05 and M is at least one substitution element chosen from; C, N, or a combination thereof, and the particles, when subjected to XRD analysis applying unmonochromated CuKα radiation, exhibit one peak at around 280 and one peak at around 52°, and where both peaks have a Full Width at Half Maximum of at least 5° when using Gaussian peak fitting.

In a second aspect, the invention relates to a negative electrode of a secondary lithium-ion electrochemical cell, comprising:
at least one particulate active material,
binder material, and
a current collecting substrate,

wherein the at least one particulate active material is embedded in the binder material to form an anode mass which is deposited as an anode mass layer onto the current collecting substrate,

characterized in that
the or one of the at least one particulate active material is predominantly amorphous silicon-containing particles made by the method according to the first aspect of the invention.

The chemical formula; Si₍₁₋ₓ₎Mₓ, where 0.005≤x<0.05 as used herein is to be interpreted and understood according to Nomenclature of Inorganic Chemistry IUPAC Recommendations 2005, IR-11.3.2 “Phases with variable composition”. I.e., the formula defines a single (phase) chemical compound having a composition which may vary solely or partially by isovalent substitution of Si-atoms for M-atoms in an amount defined by the variable “x”. Thus, the term “silicon-containing particles” as used herein means that the particles are made of a silicon dominated phase containing an alloying element distributed in the molecule structure of the silicon phase. While the terms ‘phase’ or ‘molecule structure’ can be ambiguous in the context of an amorphous material, the important feature is that the M-atoms are chemically bonded and dispersed as in an alloy such that a plurality of the nearest and next nearest neighbour atoms of a typical M-atom is a Si-atom.

The reaction kinetics in the gas reactions forming the particles from the precursor gases may vary significantly depending on which gases are applied as the first and/or the second precursor gas, and the reaction temperature at which the particles are formed such that the atomic ratio M: Si in the precursor gases may deviate significantly from the atomic ratio M: Si in the produced particles. Thus, the term “the relative amounts of the first and the second precursor gases are adapted such that the formed particles obtain an atomic ratio M: Si in the range of” as used herein means that the relative amounts of the first and the second precursor gas being mixed and homogenised is adjusted such that the resulting particles obtain the intended atomic ratio when the precursor gas mixture is heated to the intended reaction temperature and reacts to form the particles.

The adaption of the relative amounts of the first and the second precursor gas to form the intended particles falls within the ordinary skills of the person skilled in the art. For example, the adaption of the relative amounts of the precursor gases for a given first and second precursor gas and intended reaction temperature may be obtained prior to a production stage by simply performing trial and error tests to determine the relative amounts to be applied with this gas mixture and reaction temperature.

Alternatively, the atomic ratio M: Si in the formed particles may be monitored/-determined by analysing the off-gas exiting the reactor in a mass spectrometer to determine how much of the supplied first and second precursor gases are being reacted/consumed inside the reactor and then determine in an indirect way the relative amounts of M and Si in the formed particles. For example by regulating the flow rates of the first and second precursor gases being injected into the reactor and applying a mass spectrometer to measure the composition of the off-gas exiting the reactor to determine the fraction of the injected first and second precursor gas being converted to particles, and apply this information to deduce the atomic ratio M: Si in the formed particles and regulate the feed rates of the first and second precursor gases to obtain the intended atomic ratio M: Si in the particles being produced. The chemical formula Si₍₁₋ₓ₎Mₓ, where 0.005≤x<0.05, corresponds to a M: Si atomic ratio in the range [0.005025, 0.0526), such that in one example embodiment, the atomic ratio M: Si in the formed particles may be in the range of [0.005, 0.05]preferably in the range of [0.01, 0.04], preferably in the range of [0.01, 0.03] and most preferably in the range of [0.01, 0.02]. These atomic ratios correspond approximately to predominantly amorphous silicon of formula: Si₍₁₋ₓ₎Mₓ, where 0.005≤x<0.05, preferably 0.01≤x<0.04, more preferably 0.01≤x<0.03, and most preferably 0.01 K x K 0.02, respectively. M is a substitution element chosen from C, or N.

X-ray diffraction (XRD) (when XRD is applied on particulate material it may also be denoted as powder X-ray diffraction (PXD) in the literature) give different diffraction patterns for crystalline and amorphous materials, respectively. Crystalline materials, due to their high degree of ordering and symmetry in their atomic structure, tend to give sharp peaks, Bragg peaks, in XRD-measurements. For crystalline silicon materials, the XRD-analysis typically gives sharp peaks at 28.4°, 47.4°, and at 56.1° in the measured diffraction patterns. In comparison, amorphous materials which lack the long-range order characteristic of crystalline molecular structures, typically gives broader peaks being significantly more “smeared-out” in the measured diffraction patterns. Amorphous silicon typically gives rounded peaks at 280 and 52°. These rounded peaks can be fitted with a Gaussian fit to reduce noise, and to get a well-defined value for the maximum and the width of the peak. Such a fit can be performed by any skilled XRD operator.

Also, the “sharpness” of a peak may be applied to distinguish between crystalline and amorphous materials. The typical Full width at half maximum (FWHM) of an XRD-peak for crystalline silicon is less than 2°, while the FHWM for amorphous silicon is typically larger than 5° when measured with a diffractometer applying unmonochromated CuKα radiation, and using a Gaussian fit to reduce measurement noise. Full width at half maximum (FWHM) is the width of the peak curve measured between those points on the y-axis which are half the maximum amplitude of the peak curve (after subtracting the background signal and/or signal from the sample holder). Samples containing both amorphous and crystalline silicon will obtain a diffraction pattern in XRD-analysis showing both sharp Bragg-peaks typical of the crystalline phase and the broader, more Gaussian peaks typical for the amorphous phase. The diffraction pattern may be applied to estimate the crystalline fraction of the sample from the ratio of area under the Bragg peak(s) above an amorphous broad peak and the total area of the broad peak and the Bragg peaks. A linear background should be subtracted from the calculation prior to the calculations, such as shown in FIG. 6.

The angles and angle tolerances in the XRD analysis as applied herein refer to use of a diffractometer applying unmonochromated CuKα radiation since the radiation has high intensity and a wavelength of 1.5406 Å which corresponds well with the interatomic distances in crystalline solids making the analysis sensitive to presence of crystalline phases in the silicon particles. XRD analysis applying diffractometers with CuKα radiation is for the same reason the natural choice and thus the most widely used method in XRD analysis and is well known and mastered by the skilled person. Other diffractometers applying radiation with other wavelengths which may give different angles and angle tolerances. However, the skilled person will know how to convert these values from one radiation source to another. The particles made by the method according to the first aspect of the invention are shown by X-ray diffraction (XRD) analysis to have a predominantly amorphous molecular structure, as can be seen from FIG. 2. The figure presents a graphical plot representing measured diffraction patterns for three samples of particles made by the method according to the first aspect of the invention. The measured diffraction patterns for all three samples exhibit a peak at around 280 and one peak at around 52°, and both peaks (for all samples) have a FHWM around or larger than 5° when estimated using Gaussian peak fitting. The XRD-analysis shows that the Si₍₁₋ₓ₎Mₓ, where 0.005≤x<0.05, particles of the present invention predominantly have an amorphous molecular structure. Without being bound by theory it is believed that the substitution of Si-atoms with a substitution element, M, e.g. carbon-atoms, in the molecule structure of the silicon host material causes “disruptions” in the silicon molecular preventing the gas reaction process from forming silicon phases having any long-range orders in the molecular structure characteristic of crystalline silicon and/or any reorganization process which also may occur at the same temperatures.

Amorphous materials, see e.g. ref. [4], have some internal structure providing a short-range order at the atomic length scale due to the nature of the chemical bonding. This internal structure may be considered consisting of interconnected structural blocks. These blocks may or may not be similar to the basic structural units found in the corresponding crystalline phase, i.e. may or may not be providing the material with very small crystalline-resembling domains. Furthermore, for very small crystals, relaxation of the surface and interfacial effects distorts the atomic positions decreasing the structural order. Even the most advanced structural characterization techniques such as x-ray diffraction and transmission electron microscopy have difficulty in distinguishing between amorphous and crystalline structures on these length scales.

Thus, since it is difficult to determine by structural characterization techniques whether the silicon material of the particles made by the first aspect of the invention are completely amorphous or contain small crystalline domains at the atomic length scale, the term “predominantly amorphous” as used herein, encompasses silicon materials having a 100% amorphous molecular structure to silicon materials containing very small crystalline domains (practically undetectable by XRD-analysis) at the atomic length scale. It is also reasonable to believe that the benefits of the amorphous materials in the anode (i.e. less directional stress and faster charging) is maintained even when the material also contains very small crystallites, typically less than 1 nm, so that atoms with nearest neighbour distances distorted by grain boundaries make up a similar mass fraction as the atoms where all nearest neighbours are in crystalline order. The predominantly amorphous silicon-containing particles made by the invention according to the first aspect encompasses any particle comprising a chemical compound of formula: Si₍₁₋ₓ₎Mₓ, where 0.005≤x<0.05 and M is a substitution element chosen from; C, or N, and where the particles, when subjected to XRD analysis applying unmonochromated CuKα radiation, exhibit one peak at around 280 and one peak at around 52°, and where both peaks have a Full Width at Half Maximum of at least 5° when using Gaussian peak fitting.

The particles according to the first aspect of the invention are at least for some substitution elements observed to exhibit the counterintuitive property of being more heat tolerant, i.e. the crystallization temperature increases, with lesser content of the substitution element M. Experiments made by the inventors showed that amorphous Si_{0.96}C_{0.04} particles made from silane and ethene exposed for a longer heat treatment (in this case 2 hours) will stay amorphous up to 800° C., but start to crystallize somewhere between 800 and 820 C. Si_{0.92}C_{0.08} particles made in exactly the same process, however, see such a transition at a temperature between 780 and 800° C. The x-ray characterization of these two materials after different heat exposures are shown in FIGS. 3 and 4. For comparison, pure amorphous silicon particles (Si) with identical size will fully crystallize at a temperature well below 780° C. as shown in FIG. 5. Without being bound by theory, it is possible to speculate that the crystallization is dominated by carbon or carbon vacancy migration, and that this can explain the counter intuitive result. The XRD peak first appearing, near 35°, is usually associated with SiC crystalline phases, thus increased amounts of C can apparently lead to increased probability of SiC crystal formation.

Another beneficial property of the particles according to the first and second aspect of the invention is that lower contents of the substitution element M is observed (when M is carbon) to give an increase in the lithium mobility and a decrease in the electric resistivity. Thus, the particles according to the invention has the advantage of gaining a relatively high temperature tolerance/crystallization temperature at low substation levels having small/negligible negative effects on the capacity and transport properties of the active material/particles.

A further beneficial property of the particles according to the first and second aspect of the invention is that lower contents of the substitution element M normally will imply higher charging capacity for the material as none of the substitution elements, M, are known to host as much lithium as silicon is.

The term “first precursor gas of a silicon containing compound” as used herein means any silicon containing chemical compound being in the gaseous state and which reacts to form Si-particles at the intended reaction temperatures. Examples of suited first precursor gases include, but is not limited to, silane (SiH₄), disilane (Si₂H₆), and trichlorosilane (HCl₃Si), or a mixture thereof. Likewise, the term “second precursor gas of a substitution element, M, containing compound” as used herein means any chemical compound containing the substitution element M and which is in the gaseous state and participates in the gas reactions and causes M-atoms to be incorporated into the molecule structure of the Si-particles being formed when heated to the intended reaction temperatures. Examples of suited second precursor gases include, but is not limited to alkanes, alkenes, alkynes, aromatic compounds, or hydrides of N, hydrogen cyanide, and mixtures thereof.

Especially preferred example embodiments of precursor gas, i.e. the homogeneous gas mixture of a gaseous silicon and hydrogen compound and a gaseous substitution element M and hydrogen compound, are either silane (SiH₄) or disilane (Si₂H₆) mixed with a hydrocarbon gas chosen from one of; methane (CH₄), ethane (C₂H₆), propane (C₃H₈), ethene (C₂H₄), ethyne (C₂H₂), and mixtures thereof.

The notation for intervals as used herein follows the international standard ISO 80000-2, where the brackets “[” and “]” indicate a closed interval border, and the parenthesises “(“and”)” indicate an open interval border. For example, [a, b] is the closed interval containing every real number from a included to b included: [a, b]={x ∈ [symbol] | a≤x<b}, while (a, b] is the left half-open interval from a excluded to b included: (a,b]={x ∈ [symbol] | a<x≤b}.

The production yield in gas phase reaction processes, defined as the ratio of mass of precursor gas being fed to the reactor over the mass of produced particles, is shown to be dependent on process parameters such as the concentration of the precursor gas in the condensation zone, the reaction temperature of the condensation zone, and/or the residence time of condensation gases at the condensation zone. In general, the higher reaction temperature, the higher dissociation degree of the precursor gases and thus higher production yields. Thus, since the predominantly amorphous silicon-containing particles of the invention are observed to maintain their predominantly amorphous structure at significantly higher temperatures, roughly around 50° C. higher, than which amorphous (pure) silicon particles are observed to transform to crystalline silicon, the method according to first aspect of the invention has the advantage of a significantly improved production yield as compared to production of (pure) silicon particles without compromising on the favourable amorphous structure. Raising the decomposition temperature of the homogenous mixture of the first and second precursor gas from 750° C. to 800° C. may give up to 20 percentage points increase in the production yield. This feature gives the method according to the invention a significant economic advantage since silicon hydride gases such as silane, disilane etc. are expensive.

Thus, in an example embodiment of the invention according to the first aspect of the invention, the homogeneous gas mixture may preferably be injected and heated to a temperature in the range of from 740 to 850° C., preferably in the range of from 780 to 830° C., and most preferably in the range of from 790 to 820° C., but where the maximum allowable temperature depends on the residence time before the particles are cooled to a temperature where crystallization cannot occur. The exact temperature limit can be established for a specific reactor geometry and residence time through trial and error experiments.

A further advantage of the relatively high reaction temperature is that the dissociation reactions of the precursor gases becomes better driven towards complete dissociation and thus more effectively drives off hydrogen from the condensed phase. This is advantageous since hydrogen in the active material of the anode may potentially cause irreversible loss of capacity of the electrochemical cell by irreversible formation of lithium hydride.

The particle size of particles made by nucleation and growth in gas phase is dependent on the precursor gas concentration in the condensation zone. In general, the higher the precursor gas concentration, the larger particles are formed. To enable making smaller particles, the precursor gases may be diluted in an inert gas such as e.g. hydrogen gas. The choice of hydrogen to dilute the precursor gas has the advantage of avoiding feeding any “foreign” element into the formation process and thus producing ultra-pure particles. Alternatively, an inert gas such as a noble gas may be applied to dilute the precursor gas. Any inert gas, i.e. a gas which will not react chemically with the precursor gases or silicon particles may be used for dilution purposes.

In an example embodiment of the invention according to the first and second aspect of the invention, the predominantly amorphous silicon-containing particles may have a BET surface area of from 10 to 250 m²/g, preferably in the range of from 15 to 170 m²/g, more preferably in the range of from 25 to 130 m²/g, and most preferably in the range of from 35 to 130 m²/g. If we, for simplicity, assume that these particles are spherical or quasi-spherical and non-porous, these BET surface areas correspond to (approximate estimates) an average particle size in the range of from 10 to 200 nm, preferably in the range of from 15 to 150 nm, preferably in the range of from 20 to 100 nm, and most preferably in the range of from 20 to 70 nm. The BET determination of the particle surface area is well known to the person skilled in the art. An example of a standard which may be applied to determine the BET surface area of the predominantly amorphous silicon-containing particles according to the first and second aspect of the invention is ISO 9277:2010.

The predominantly amorphous silicon-containing particles according to the first and second aspect of the invention may further be provided with a surface coating, preferably a carbon coating of a thickness of from 0.05-3 nm, preferably of from 0.2 to 1 nm, to enhance the surface properties, lower fire-risk and promote formation of a stable solid-electrolyte-interface (SEI). The invention is not tied to any particular coating material or method of coating the particles but may apply any coating and coating method known to the skilled person for coating silicon particles.

The relatively high heat tolerance of the predominantly amorphous silicon-containing particles of the invention is advantageous in that the particles will better tolerate the temperatures associated with formation of carbon coatings—and/or the formation of composite particles comprising the silicon nano particles—by pyrolysis without showing any significant transformation to the crystalline state. The carbon-enclosed or carbon-coated predominantly amorphous silicon-containing particles of the invention may maintain their predominantly amorphous structure even through a pyrolysis process. The quality of the pyrolysis will often depend on temperature, and it may be preferable to go to 600° C., 700° C. or preferably 800° C. or even 900° C. to get a high-quality carbon material coating or carbon enclosure.

The predominantly amorphous structure of the silicon-containing particles of the invention makes them well suited for use as the active material in the negative electrode of secondary lithium-ion electrochemical cells (batteries). The amorphous structure is known to make the first charging possible with less overpotential, they will be more stress tolerant, and the particles will be more resilient toward the volume variations associated with the lithiation/delithiation cycles upon charging and discharging, respectively.

In a third aspect, the invention relates to predominantly amorphous silicon-containing particles, wherein:

the particles comprises a chemical compound of formula: Si₍₁₋ₓ₎Mₓ, where 0.005≤x<0.02 and M is at least one substitution element chosen from C or N, or a combination thereof, and

where the particles, when subjected to XRD analysis applying unmonochromated CuKα radiation, exhibit one peak at around 280 and one peak at around 52°, and where both peaks have a Full Width at Half Maximum of at least 5° when using Gaussian peak fitting.

The term “active material” as used herein, refers in general to the chemical compounds/material of the electrodes (anode and cathode) which take and give the lithium-ions and electrons to generate or store energy, i.e. the material which undergoes lithiation and delithiation in the charge/discharge-cycling of the electrochemical cell. More specifically, the active material of the negative electrode according to the third aspect of the invention refers to the predominantly amorphous silicon-containing particles according to the first or the second aspect of the invention.

In secondary electrochemical cells, the chemical half-cell reactions at the electrodes switch from oxidation to reduction reactions with the charge and discharge state of the charge/discharge cycle, respectively. As used herein, the term “negative electrode” is applied to denote the electrode of the electrochemical cell at which the oxidation side of the chemical reaction(s) takes place during discharge, i.e. the negative electrode is the electron producing electrode when drawing power out of the electrochemical cell. The negative electrode may also be denoted as the anode in the literature. The terms anode and negative electrode may be used interchangeably herein.

The negative electrode according to the third aspect of the invention may apply any conductive substrate known or conceivable to the skilled person being suited for use as the current collector in the negative electrode of secondary lithium-ion electrochemical cells. Examples of suited conductive substrates include but is not limited to; foils/sheets of graphite, aluminium or copper.

The negative electrode according to the third aspect of the invention may apply any binder material known or conceivable to the skilled person being suited for use a binder in the negative electrode of secondary lithium-ion electrochemical cells. Examples of suited binders include but is not limited to; styrene butadiene copolymer (SBR), carboxymethylcellulose (CMC), ethylene-propylene-diene methylene (EPDM), and polyacrylic acid (PAA).

In an example embodiment, the anode mass may further comprise a particulate conductive filler material mixed with and embedded together with the particulate active material in the binder material. The negative electrode according to the third aspect of the invention may apply any conductive filler material known or conceivable to the skilled person being suited for use a conductive filler of the anode mass for the negative electrode of secondary lithium-ion electrochemical cells. Examples of suited particulate conductive filler materials include but is not limited to; carbon allotropes such as graphene, reduced graphene oxide, an elastic polymer, a predominantly carbon containing material made by pyrolysis of a carbon rich material, carbon black, carbon nanotubes, or mixtures thereof.

In a fourth aspect of the invention, the predominantly amorphous silicon-containing particles according to the first or second aspect of the invention may be used to form composite particles, through a post-production step comprising the pyrolysis of a carbonaceous material containing a multiple of the predominantly amorphous silicon particles of the invention. Said composite particles can then again be used in the battery electrode and each composite particle may comprise from e.g. ten up to maybe a million of the predominantly amorphous silicon particles of the invention as well as an amount of carbon formed by heat treatment of a precursor material comprising carbon atoms. This precursor material may for example be a large, carbon intensive molecule like oil or pitch. Alternatively, the precursor material could be a heavily cross-linked material such as recorcinol formaldehyde or melamine-formaldehyde where the pyrolysis can be used to form a nanoporous structure or an aerogel. The pyrolysis process can be performed at >600° C., preferably >700° C., or more preferably >800° C. An example composite particle may have a similar size as the graphite particles used in today's batteries, i.e. an average cross-section distance from for example 2 to 5 micrometres.

In a fifth aspect of the invention, the predominantly amorphous silicon-containing particles according to the first and second aspect of the invention may be used to form composite particles using a graphene or graphene oxide as a conductive additive and as a protective barrier against the electrolyte. Said composite particles can then again be used in the battery electrode and may comprise from e.g. ten up to maybe a million of the predominantly amorphous silicon particles of the invention as well as an amount of graphene or reduced graphene oxide formed by heat treatment of a precursor material comprising oxidized graphene or graphene oxide. The reduction process can be performed at >600° C., preferably >700° C., or more preferably >800° C. An example composite particle may have a similar size as the graphite particles used in today's batteries, i.e. an average cross-section distance from for example 2 to 5 micrometres. The composite particles may further include a binder or other component ensuring the geometrical stability of the composite particle in later production steps.

In a sixth aspect of the invention, the predominantly amorphous silicon-containing particles according to the first and second aspect of the invention may be used to form composite particles using an elastic binder as barrier against the electrolyte. The composite particles could also comprise a conductive additive. Said composite particles can then again be used in the battery electrode and may comprise from e.g. ten up to maybe a million of the predominantly amorphous silicon particles of the invention. The elastic binder could be any elastic polymer or plastic, including known elastomers such as imides, amides, silicones, styrene-butadiene-rubber, nitrile rubber. An example composite particle may have a similar size as the graphite particles used in today's batteries, i.e. an average cross-section distance from for example 2 to 5 micrometres.

### LIST OF FIGURES

FIG. 1 is a diagram showing an XRD-analysis of silicon particles made at three different temperatures.

FIG. 2 is a diagram showing an XRD analysis of various samples of Si_{0.99}C_{0,01} and Si_{0.98}C_{0,02} made above 800° C. (samples R11_FA, R11_FB, and R11_FC) in nearly the same process as in FIG. 1 and still being fully amorphous.

FIG. 3 is a diagram showing an XRD analysis of a sample of Si_{0.96}C_{0,04} after heat treatment for two hours at 700° C. (R18-F1 700) and 800° C. (R18-F1 800), respectively. The curves show that Si_{0.96}C_{0,04} stays amorphous even after 2 hours at 800° C.

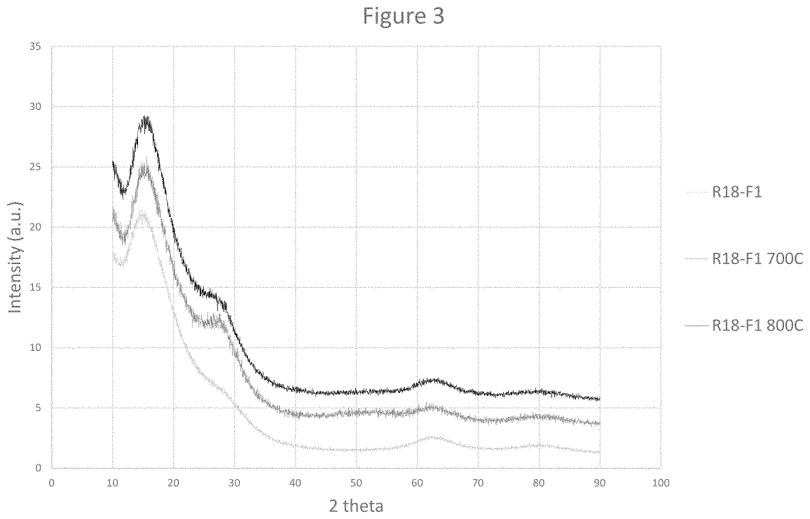

FIG. 4 is a diagram showing an XRD analysis of Si_{0.92}C_{0,08} after heat treatment for two hours at 700° C. (R18-F2 700) and 800° C. (R18-F2 800), respectively. The curves show that Si_{0.92}C_{0,08} stays amorphous after 2 hours at 700° C. but starts to crystallize if it is exposed for 2 hours at 800° C.

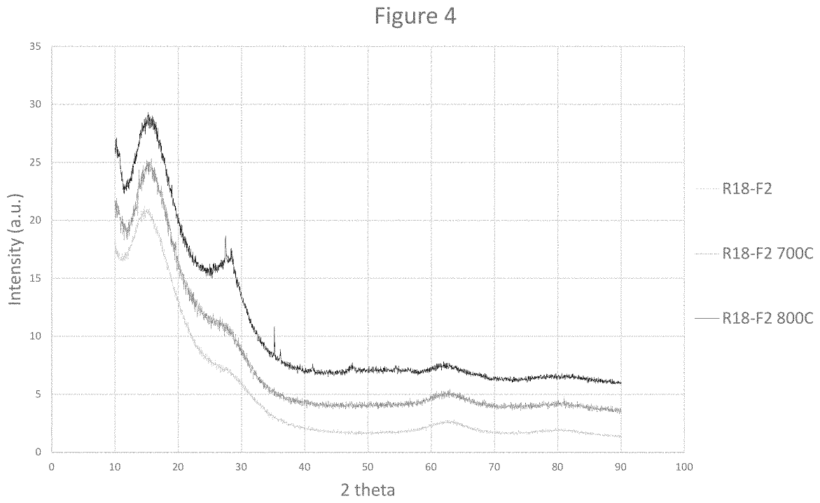

FIG. 5 is a diagram showing an XRD analysis of Si showing that the material is fully crystalline if it is exposed for to 2 hours at 780° C.

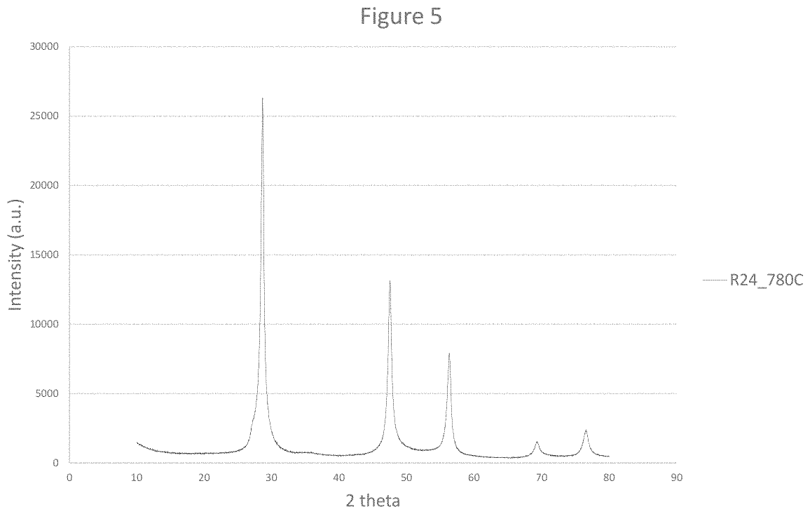

FIG. 6 is a XRD-diagram of a sample with both crystalline and amorphous silicon and where the area under the Bragg peak is marked as dark grey and the area under the broad peak subtracted an area und a linear background is shown as light grey.

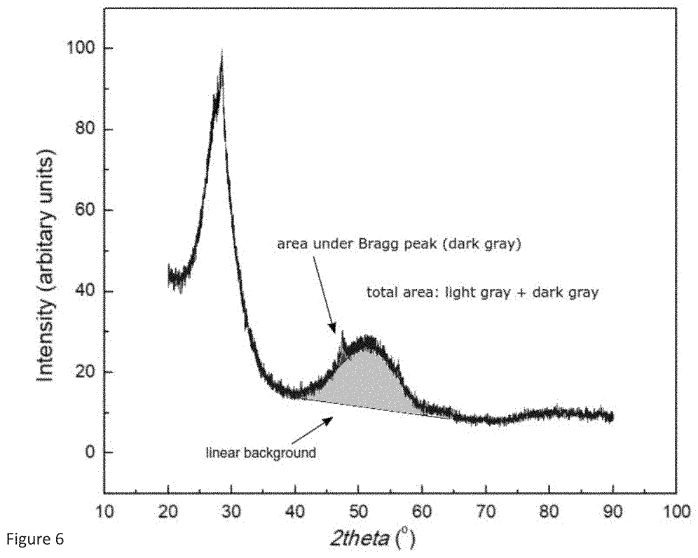

Verification of the Invention

The invention will be described in further detail by way of example embodiments.

### Comparison Example

Three samples of (pure) silicon particles were made by pre-heating a homogenous gas mixture of 33% silane diluted in hydrogen gas to about 400° C. and introducing the gas into a decomposition reactor and mixing the silane gas with preheated hydrogen gas having a temperature of 710° C., 745° C. and 770° C., respectively. The residence time in the reactor was approximate 1.5 seconds. The resulting silicon particles were rapidly cooled to below 300 C and collected by filtration.

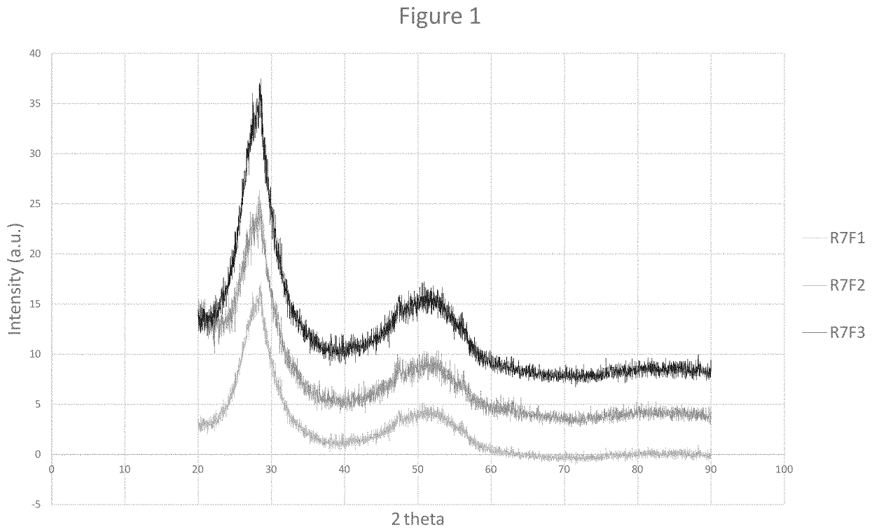

The sample particles were then analysed by XRD to investigate their atomic structure. The particles made at 710° C. (marked as RTF1 on FIG. 1) has a XRD-curve typical of amorphous silicon, the particles made at 745° C. (marked as RTF2 on FIG. 1) has a XRD-curve indicating some formation of crystalline silicon, while the particles made at 770° C. (marked as RTF3 on FIG. 1) has a XRD-curve typical of crystalline silicon.

### Example 1

An example embodiment of the predominantly amorphous silicon particles according to the invention may be prepared as follows:

A homogeneous mixture of silane gas and ethene was preheated to about 400° C. and introduced into a reactor chamber. There the homogeneous mixture of silane gas and ethene was further mixed with an inert gas (nitrogen) which was preheated to a temperature giving a temperature in the resulting gas mixture of 810° C. The relative amounts of the gases in the final mixture were approximately 28 mole % silane, 1.5 mole % ethene and the rest (70 mole %) was nitrogen, which gave an atomic ratio of C: Si in the gas mixture of 0.05. The resulting particles, however, had an atomic ratio of C: Si of 0.02, i.e. the particles consisted of predominantly amorphous Si_{0.98}C_{0.02}.

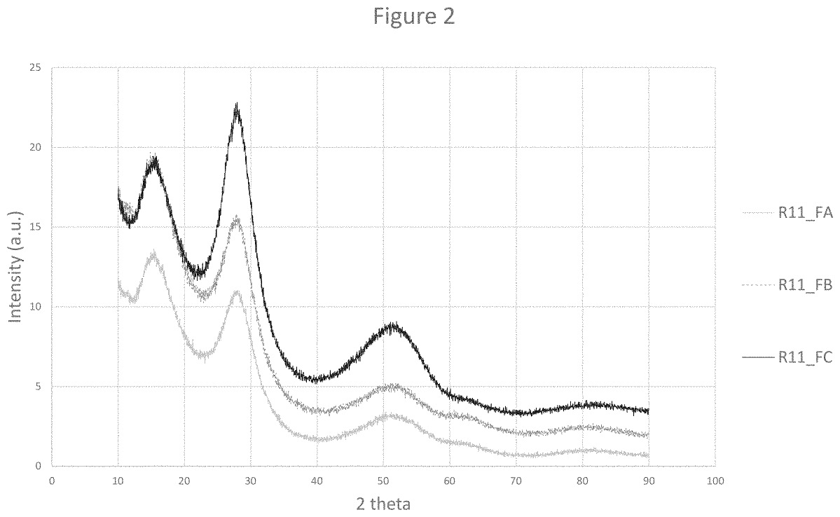

The residence time in the reactor was approximately 1.0 seconds. The exhaust gas and particles exiting the reactor space were thereafter rapidly cooled and collected in a filter. The particles were analysed by XRD to investigate their atomic structure. The result is shown in FIG. 2 as the curve marked with R11_FA. The XRD-curve is typical for silicon having an amorphous molecular structure.

### Example 2

Two more example embodiments of particles were made in the similar way as in example 1, except that the gas mixture was heated to 800° C. in the reactor for material R11_FB and the ethene concentration was reduced by 50% in sample R11_FC in order to make Si_{0.99}C_{0.01}. These particle samples were analysed by XRD and the result is shown in FIG. 2 as the curve marked R11_FB and R11_FC, respectively. Both curves are typical for amorphous silicon.

### Example 3

Three more embodiments of particles were made in the similar way as in example 1, except that the gas mixture comprised silane, ethene, ammonia and nitrogen. These samples where characterized using Differential Scanning Calorimetry to determine the crystallization temperature from the energy released during crystallization. The nitrogen content is not as easy to measure as the carbon content for these low inclusions, but based on linear extrapolation from samples with higher nitrogen content, and analysing the gas consumption in the reaction, is was estimated that the particles had compositions Siₓ,C_{y},N_{z} of: Si0_{0.984}C_{0.016}N₀, Si_{0.992},C₀₀₈,N₀, and Si_{0.976}C_{0.012}N_{0.012}.

All these samples showed an increased crystallization temperature as compared to the comparison particles of pure silicon described above, with the sample of estimated composition of Si_{0.976}C_{0.012}N_{0.012} having the highest crystallization temperature of 794° C. The two other samples showed a crystallinity temperature of being at least 10° C. lower, i.e. somewhat less than 784° C.

### REFERENCES

1 Qi et al. (2017), “Nanostructured anode materials for lithium-ion batteries: principle, recent progress and future perspectives”, J. Mater. Chem. A, vol. 5, pp. 19521-19540
2 Sourice et al. (2016), “Core-shell amorphous silicon-carbon nanoparticles for high performance anodes in lithium-ion batteries”, Journal of Power Sources, vol. 328, pp. 527-535.
3 Sourice et al. (2015), “One-Step Synthesis of Si@C Nanoparticles by Laser Pyrolysis: High Capacity Anode Material for Lithium-Ion Batteries”, ACS Appl. Mater. Interfaces, vol. 7, pp. 6637-6644, DOI: 10.1021/am5089742
4 https://en.wikipedia.org/wiki/Amorphous_solid
5 Berla, Lucas A. Lee, Seok Woo; Ryu, Ill; Cui, Yi; Nix, William D. (2014), “Robustness of amorphous silicon during the initial lithiation/delithiation cycle”, Journal of Power Sources. 258: 253-259. Bibcode: 2014JPS . . . 258.. 253B. doi:10.1016 jpowsour.2014.02.032.
6 Wang Y. K., Chou S. L., Kim J. H., Liu H. K. and Dou S. X., “Nano-composites of silicon and carbon derived from coal tar pitch: Cheap anode materials for lithium-ion batteries with long cycle life and enhanced capacity” Electrochim. Acta, 2013, 93, 213 221.
7 Dahn, J. R., Zheng, T., Liu, Y., Xue, J. S., (1995), “Mechanisms for Lithium Insertion in Carbonaceous materials” Science, Vol. 270, Issue 5236, pp. 590-593.
8 Escamilla-Perez, A. M., Roland, A., Giraud, S., Guiraud, C., Virieux, H., Demoulin, K., Oudart, Y., Louvainac, N., and Monconduit, L., (2019), “Pitch-based carbon/nano-silicon composite, an efficient anode for Li-ion batteries”, RCS Advances, Vol. 9, pp. 10546-10553.

1. A method for manufacturing predominantly amorphous silicon-containing particles comprising a chemical compound of formula: Si₍₁₋ₓ₎Cₓ, where 0.005≤x<0.05, and where the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting,
wherein the method comprises:
forming a homogeneous gas mixture of a first precursor gas of a silicon containing compound and at least one second precursor gas of a substitution element M containing compound,
injecting the homogeneous gas mixture of the first and second precursor gases into a reactor space where the precursor gases are heated to a temperature in the range of from 700 to 900° C. so that the precursor gases react and form particles, and
collecting and cooling the particles to a temperature in the range of from ambient temperature up to about 350° C., wherein
the relative amounts of the first and the second precursor gases are adapted such that the formed particles obtain an atomic ratio C: Si in the range of [0.005, 0.05).

2. The method according to claim 1, wherein the first precursor gas is: Silane (SiH₄), disilane (Si₂H₆), trichlorosilane (HCl₃Si), or a mixture thereof.

3. The method according to claim 1, wherein the second precursor gas is chosen from: methane (CH₄), ethane (C₂H₆), propane (C₃H₈), ethene (C₂H₄), ethyne (C₂H₂), alkanes, alkenes, alkynes, or mixtures thereof.

4. The method according to claim 1, wherein the relative amounts of the first and the second precursor gases are adapted such that the formed particles obtain an atomic ratio C: Si in the range of [0.01, 0.04], preferably in the range of [0.01, 0.03], and most preferably in the range of [0.01, 0.02].

5. The method according to claim 1, wherein the homogeneous gas mixture of the first and second precursor gases is preheated to a temperature in the area of from 400 to 500° C. prior to insertion in the reactor space, and then further heated after injection into the reactor space to a temperature in the range of from 740 to 850° C., preferably in the range of from 780 to 830° C., and most preferably in the range of from 790 to 820° C.

6. The method according to claim 1, wherein the gas mixture also comprises hydrogen, nitrogen, a noble gas like Helium, Neon, Argon, or any other gas that will not chemically react with the precursor gases at the temperatures specified.

7. The method according to claim 1, wherein the relative amounts of the first and the second precursor gases are adapted by regulating the flow rates of the first and second precursor gases being injected into the reactor and applying a mass spectrometer to measure the composition of the off-gas exiting the reactor to determine the fraction of the injected first and second precursor gas being converted to particles, and apply this information to deduce the atomic ratio C: Si in the formed particles and regulate the feed rates of the first and second precursor gases to obtain the intended atomic ratio C: Si in the particles being produced.

8. A method according to claim 1, wherein the method further comprises the step of depositing a 0.05-3 nm, preferably a 0.2 to 1 nm thick layer of carbon onto the surface of the condensed particles.

9. Predominantly amorphous silicon-containing particles, wherein
the particles comprises a chemical compound of formula: Si₍₁₋ₓ₎Cₓ,
where 0.005≤x<0.02, and
the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting.

10. Predominantly amorphous silicon-containing particles according to claim 9, wherein the particles comprises a compound of formula: S₍₁₋ₓ₎Cₓ, where 0.01≤x<0.02.

11. Predominantly amorphous silicon-containing particles according to claim 9, wherein the particles have an average particle size in the range of from 10 to 200 nm, preferably in the range of from 15 to 150 nm, preferably in the range of from 20 to 100 nm, and most preferably in the range of from 20 to 70 nm.

12. (canceled)

13. Predominantly amorphous silicon-containing particles according to claim 9, wherein the particles are coated with a from 0.05-3 nm, preferably of from 0.2 to 1 nm thick coating of carbon.

14. A negative electrode for a secondary lithium-ion electrochemical cell, comprising:
at least one particulate active material,
a particulate conductive filler material,
binder material, and
a current collecting substrate,
wherein
the at least one particulate active material is embedded in the binder material to form an anode mass which is deposited as an anode mass layer onto the current collecting substrate,
the or one of the at least one particulate active material is predominantly amorphous silicon-containing particles, wherein
the particles comprises a chemical compound of formula: Si₍₁₋ₓ₎Cₓ,
where 0.005≤x<0.04, and
wherein the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting.

15. A negative electrode according to claim 14, wherein the conductive substrate is a foil or a sheet of either graphite, Cu or Al.

16. A negative electrode according to claim 14, wherein the binder is either a styrene butadiene copolymer, a carboxymethylcellulose, an ethylene-propylene-diene methylene (EPDM), a polyacrylic acid (PAA).

17. A negative electrode according to claim 14, wherein the anode mass further comprises a particulate conductive additive material mixed with and embedded together with the particulate active material in the binder material.

18. A negative electrode according to claim 17, wherein the particulate conductive filler material is a carbon black, carbon nanotubes, graphene, or a mixture thereof.

19. A composite particle for use in the negative electrode in a secondary lithium-ion electrochemical cell, wherein the composite particle comprises:
a plurality of predominantly amorphous silicon-containing particles,
wherein
the particles comprises a chemical compound of formula: Si(1−x)CAM,
where 0.005≤x<0.04
and where
the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting, and
a predominantly carbon containing material made by pyrolysis of a carbon rich material.

20. A composite particle for use in the negative electrode in a secondary lithium-ion electrochemical cell, wherein the composite particle comprises:
a plurality of predominantly amorphous silicon-containing particles, wherein the particles comprises a chemical compound of formula: Si₍₁₋ₓ₎Cₓ,
where 0.005≤x<0.04, and
the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting, and
an elastic polymer.

21. A composite particle for use in the negative electrode in a secondary lithium-ion electrochemical cell, wherein the composite particle comprises:
a plurality of predominantly amorphous silicon-containing particles, wherein the particles comprises a chemical compound of formula: Si₍₁₋ₓ₎Cₓ,
where 0.005≤x<0.04
and where
the particles, when subjected to XRD analysis applying unmonochromated CuKα radiation, exhibit one peak at around 28° and one peak at around 52°, and where both peaks have a Full Width at Half Maximum of at least 5° when using Gaussian peak fitting, and
graphene or reduced graphene oxide.

22. Use of a composite particle according to claim 19 in a negative electrode in a secondary lithium-ion electrochemical cell.
